(19) United States
(12) Patent Application Publication
(10) Pub. No.: US 2016/0283939 A1
(43) Pub. Date: Sep. 29, 2016

(54) SYSTEM AND METHOD TO PREVENT LOSS OF BITCOINS DUE TO ADDRESS ERRORS

(71) Applicant: QUALCOMM Incorporated, San Diego, CA (US)

(72) Inventor: Keir Finlow-Bates, Kangasala (FI)

(21) Appl. No.: 14/668,778

(22) Filed: Mar. 25, 2015

(51) Int. Cl. G06Q 20/40; G06Q 20/06; H04L 12/26

(52) U.S. Cl. CPC G06Q 20/405; H04L 43/0864; G06Q 20/065

(57) ABSTRACT

Aspects of the invention are related to a method for determining whether a transaction message of a digital currency system is valid. The exemplary method comprises: receiving the transaction message, the transaction message referencing in an input a previous output associated with a timeout value; determining whether a time as specified by the timeout value has passed; determining that the transaction message is valid in response to determining that the time as specified by the timeout value has not passed; and collecting the transaction message into a block of a block chain in response to determining that the transaction message is valid.

### FIELD

The subject matter disclosed herein relates to digital currencies, and more particularly to methods, apparatuses, and systems for preventing the loss of funds due to address errors.

### BACKGROUNDS

Bitcoin is a digital currency and online payment system. Exchanges exist where customers may buy or sell Bitcoins with legal tender from various countries. There are currently over 13 million Bitcoins issued, which represent a significant monetary value.

When transferring Bitcoins from one Bitcoin address to another, if an erroneous receiving Bitcoin address (e.g., a Bitcoin address referenced in an output of a transaction message) is used, through either user error (e.g., typing a wrong Bitcoin address) or system error (e.g., software bugs), or if the private key associated with the receiving Bitcoin address is lost, the Bitcoins transferred to such a Bitcoin address may be lost forever. Such losses are a serious concern especially when large sums of Bitcoins are transferred.

### SUMMARY

Aspects of the invention are related to a device for determining whether a transaction message of a digital currency system is valid. The device performs operations comprising: receiving the transaction message, the transaction message referencing in an input a previous output associated with a timeout value; determining whether a time as specified by the timeout value has passed; determining that the transaction message is valid in response to determining that the time as specified by the timeout value has not passed; and collecting the transaction message into a block of a block chain in response to determining that the transaction message is valid.

### BRIEF DESCRIPTION OF THE DRAWINGS

FIG. 1 is a diagram illustrating an example Bitcoin system.

FIG. 2 illustrates an embodiment of a device with which embodiments of the disclosure may be practiced.

FIG. 3 is a diagram illustrating an example extended transaction message.

FIG. 4 is a flowchart illustrating an example method implemented with a miner for determining whether a transaction message is valid.

### DETAILED DESCRIPTION

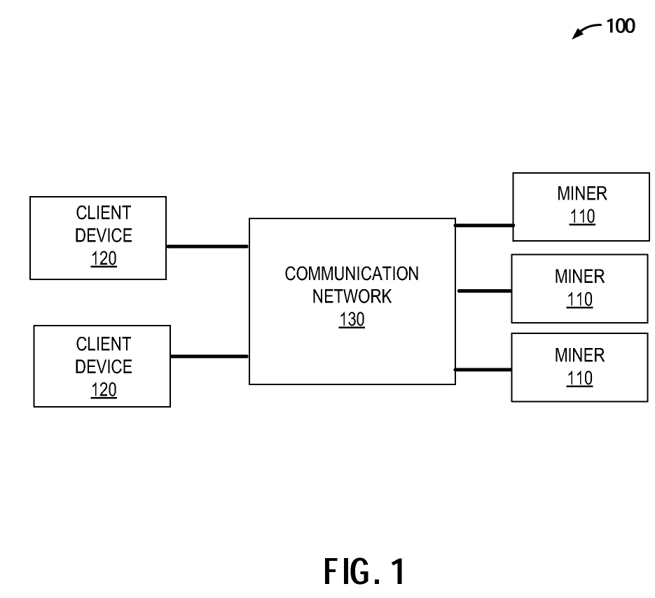

Referring to FIG. 1, a diagram illustrating an example Bitcoin system 100 is shown. The Bitcoin system 100 comprises one or more miners 110 and may also comprise one or more client devices 120. The miners 110 and the client devices 120 are interconnected through a communication network 130, such as the Internet. In some embodiments, a same device may act both as a miner 110 and a client device 120. The number of the miners 110 or the client devices 120 does not limit the disclosure in any way.

The miners 110 maintain a publicly distributed ledger called the block chain, in which Bitcoin transactions are recorded. The block chain is a decentralized database stored at each of the miners 110 and distributed in a peer-to-peer fashion. When a client device 120 broadcasts a transaction message through the communication network 130, a miner 110 may independently verify the validity of the transaction based on its own copy of the current block chain. The verification of the transaction message prevents double spending. The Bitcoin system 100 is designed such that, approximately every ten minutes, one of the miners 110 may create a valid new block incorporating a group of newly accepted transactions and broadcast the new block through the communication network 130 to the other miners 110. The new block may be independently verified by each of the other miners 110 and appended to their copies of the block chain. The client devices 120 may also download the block chain from the miners 110 to examine past transactions recorded in the block chain. Generally the client devices 120 may also store a copy of the updated block chain locally.

Therefore, miners 110 provide a record-keeping service by verifying newly broadcast transaction messages and collecting a group of valid new transactions into a new block of the block chain. A new block contains a cryptographic hash of the previous block, thus “chaining” the new block to the previous block. To be valid, a new block must also contain a proof-of-work, which consists of a difficulty target and a nonce. To create a valid new block, a miner 110 needs to find a nonce that yields a hash of the new block that is numerically smaller than a number indicated by the difficulty target. Due to the nature of the cryptographic hash function, the validity of a new block containing a particular nonce is computationally easy to verify, but to create such a valid new block is computationally hard. According to the Bitcoin protocol, the difficulty target is updated every 2016 blocks based on the total computational capability across the whole system 100, such that it always takes approximately ten minutes to find a new valid block. The “chaining” of the blocks and the proof-of-work system make it extremely difficult to falsify the block chain, as falsification of a single block necessitates modification of all subsequent blocks to maintain the validity of the whole block chain, and this is difficult for an attacker with limited computational resources as compared to the combined computational power of all the other miners 110. As new blocks are created and incorporated into the block chain all the time, the difficulty of falsifying a particular past block increases as time passes. A transaction is deemed to have been confirmed across the Bitcoin system 100 when the block containing the transaction has been followed by a sufficient number of subsequent blocks in the block chain.

Each Bitcoin transaction message comprises one or more inputs and one or more outputs. Inputs represent payers, and outputs represent payees. A payer may execute a payment by broadcasting a transaction message through the communication network 130 using a client device 120. Each output contains a payee Bitcoin address and an amount of Bitcoins to be transferred to the payee Bitcoin address. A Bitcoin address is a 160-bit hash of a public key of an Elliptic Curve Digital Signature Algorithm (ECDSA) public/private key pair. A party owns a Bitcoin address by possessing the corresponding public/private key pair. With the exception of the input of generation transactions (a miner 110 may generate a certain amount of new Bitcoins with the creation of a new block), each input references an output of a previous transaction. To be valid, an input contains the public key associated with the Bitcoin address contained in the referenced output, and is signed with the corresponding private key. The total value of previous outputs referenced in inputs of a transaction is redeemed in whole at once with the transaction. If a certain fraction of the total value is to be retained by the payer (i.e., a change), one or more separate outputs corresponding to the change are included in the transaction. The change may go back to the original Bitcoin address, or may go to a new Bitcoin address. The difference between the total value of the inputs and the total value of the outputs is awarded as a transaction fee to the miner 110 that collects the transaction into a block.

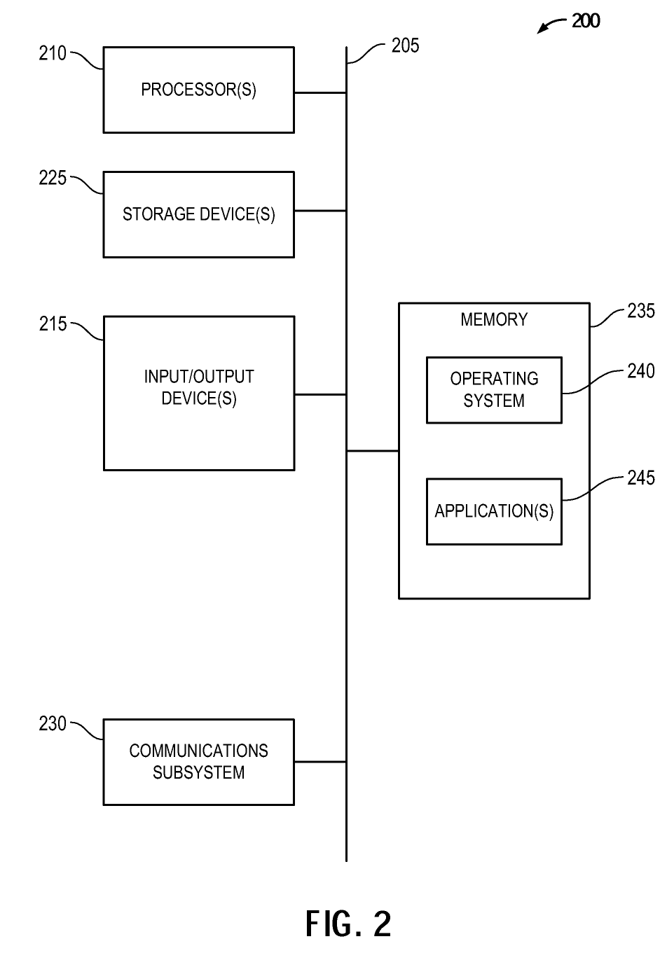

An example device 200 is illustrated in FIG. 2. The device 200 may correspond to either a miner 110 or a client device 120 of FIG. 1. The device 200 is shown comprising hardware elements that can be electrically coupled via a bus 205 (or may otherwise be in communication, as appropriate). The hardware elements may include one or more processors 210, including without limitation one or more general-purpose processors and/or one or more special-purpose processors (such as digital signal processing chips, graphics acceleration processors, and/or the like); one or more input/output devices 215, and can further include without limitation a mouse, a keyboard, a speaker, a printer, and/or the like.

The device 200 may further include (and/or be in communication with) one or more non-transitory storage devices 225, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The device 200 might also include a communication subsystem 130, which can include without limitation a modem, a network card (wireless or wired), an infrared communication device, a wireless communication device and/or chipset (such as a Bluetooth device, an 802.11 device, a Wi-Fi device, a WiMAX device, cellular communication facilities, etc.), and/or the like. The communications subsystem 230 may permit data to be exchanged with a network, other computer systems/devices, and/or any other devices described herein. In some embodiments, the device 200 may further comprise a working memory 235, which can include a RAM or ROM device, as described above.

The device 200 also can comprise software elements, shown as being currently located within the working memory 235, including an operating system 240, device drivers, executable libraries, and/or other code, such as one or more application programs 245, which may comprise or may be designed to implement methods, and/or configure systems, provided by other embodiments, as described herein. Merely by way of example, one or more procedures described with respect to the method(s) discussed below might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 225 described above. In some cases, the storage medium might be incorporated within a computer device, such as the device 200. In other embodiments, the storage medium might be separate from a computer device (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computerized device 200 and/or might take the form of source and/or installable code, which, upon compilation and/or installation on the device 200 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

If an output of a transaction message contains an erroneous Bitcoin address, the output may never be redeemed, and the associated Bitcoins may be lost forever. For example, the Bitcoin address 16QaFeudRUt8NYy2yzjm3BMvG4xBbAsBFM contains 0.01 Bitcoins and is associated with a private ECDSA key of 0. The funds associated with the Bitcoin address may never be redeemed as 0 is not a valid private ECDSA key and cannot be used to sign a transaction.

Embodiments of the disclosure are related to a new type of Bitcoin transaction message that includes a timeout field, which may be referred to hereinafter as an extended transaction message. The extended transaction message may have one timeout value that applies to all outputs, or may have separate timeout values for each of the outputs. If an output with a timeout value is not redeemed in a subsequent transaction within the time as specified by the timeout value, the output may be invalidated and the associated Bitcoin funds may go back to the original Bitcoin address or to another predesignated Bitcoin address as specified in the extended transaction message. Therefore, a permanent loss of Bitcoins may be avoided by using the extended transaction message.

In some embodiments, an extended transaction message may include a single timeout value (e.g., a transaction-wide timeout value). The single timeout value applies to all the outputs of the transaction. Bitcoin funds associated with outputs that have not been redeemed in subsequent transactions by the time specified by the timeout value are either returned to the original Bitcoin address or transferred to another predesignated Bitcoin address.

In some embodiments, each output of an extended transaction message may be associated with an individual timeout value. If an output has not been redeemed in a subsequent transaction by the time specified by the associated timeout value, Bitcoin funds associated with the output are either returned to the original Bitcoin address or transferred to another predesignated Bitcoin address.

In some embodiments, no separate address is designated for the receipt of Bitcoin funds associated with the timed-out outputs. If an output of an extended transaction message becomes invalidated because it has not been redeemed by the time specified by the timeout value, Bitcoin funds associated with the output are returned to the original Bitcoin address, which is the Bitcoin address referenced by the input of the extended transaction message. It should be appreciated that in these embodiments, the extended transaction message cannot contain more than one inputs and more than one outputs at the same time, as ambiguity as to which original address should the Bitcoin funds be returned to may arise when some but not all outputs have not been redeemed in time.

In some embodiments, an additional address is designated along with the outputs for the receipt of Bitcoin funds associated with the timed-out outputs. Initially, the extended transaction message directs no Bitcoin into this additional address. However, if an output becomes invalidated because it has not been redeemed by the time specified by the timeout value, Bitcoin funds associated with the output are transferred to this predesignated address.

In some embodiments, a timeout value less than 500 million specifies a time in the current block height (e.g., the number of blocks) of the block chain, while a timeout value greater than 500 million specifies a time in the Unix time (i.e., the number of seconds elapsed since 00:00:00 Coordinated Universal Time “UTC”, Jan. 1, 1970). It should be appreciated that this is the same time representation scheme used for the nLockTime parameter (i.e., the parameter that specifies the earliest time a transaction can be collected into a block) according to the Bitcoin protocol.

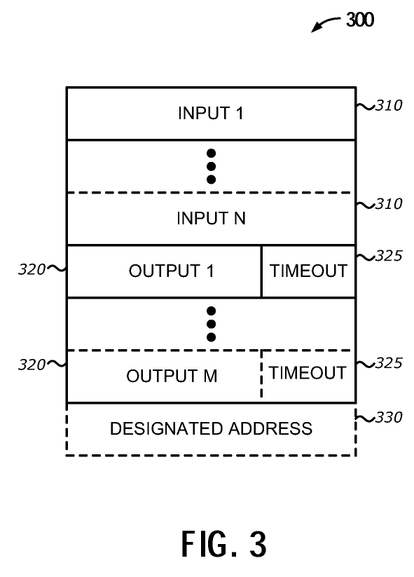

Referring to FIG. 3, a diagram illustrating an example extended transaction message 300 is shown. Details of a Bitcoin transaction message unrelated to the present disclosure have been omitted in FIG. 3 in order not to obscure the disclosure. Elements with dashed lines as boundaries may or may not be present depending on the various embodiments. The extended transaction message 300 may comprise one or more inputs 310 (INPUT 1 . . . INPUT N) and one or more outputs 320 (OUTPUT 1 . . . OUTPUT M). Further, the extended transaction message 300 may comprise one or more timeout values 325 associated with the outputs. In some embodiments, the extended transaction message 300 may comprise only a single timeout value 325 that applies to all the outputs 320. In some other embodiments, each output 320 may be associated with its own individual timeout value 325. Moreover, in some embodiments, the extended transaction message 300 may further comprise a designated address 330 for the receipt of Bitcoin funds associated with timed-out outputs. As described above, in embodiments where no designated address 330 is provided, the Bitcoin funds associated with timed-out outputs may be returned to the original address.

It should be appreciated that when the timeout occurs, no active operation on the part of either the miners 110 or of the client devices 120 is required to return or transfer the Bitcoin funds associated with the timed-out outputs. Whether a timeout has occurred for an output may be determined at the relevant time (e.g., when a transaction message attempting to redeem the output is received) by analyzing the block chain at that time.

A diagram illustrating an example extended transaction message, in which the above-described time representation scheme is utilized, is provided below:

| Version | | 19 02 00 00 00 |
|---|---|---|
| Input count | | 01 |
| Input | Previous output hash | 3F 4F A1 98 03 DE C4 D6 A8 |
| | | 4F AE 38 21 DA 7A C7 57 70 |
| | | 80 EF 75 45 12 94 E7 1F 9B 20 |
| | | E0 AB 1E 7B |
| | Previous output | 00 00 00 00 |
| | index | |
| | Script length | 8A |
| | ScriptSig | 48 30 45 02 21 00 89 49 F0 CB |
| | | 40 00 94 AD 2B 5E B3 99 D5 |
| | | 9D 01 C1 4D 73 D8 FE 6E 96 |
| | | DF 1A 71 50 DE B3 88 AB 89 |
| | | 35 02 20 79 65 60 90 D7 F6 BA |
| | | C4 C9 A9 4E 0A AD 31 1A 42 |
| | | 68 E0 82 A7 25 F8 AE AE 05 |
| | | 73 FB 12 FF 86 6A 5F 01 |
| | Sequence | FF FF FF FF |
| Output count | | 02 |
| Output 1 | Value | 62 64 01 00 00 00 00 00 |
| | Script length | 19 |
| | ScriptPubKey | 5E E3 E7 3A 79 59 00 3B AC |
| | | 38 D6 68 D9 29 FD 91 80 23 88 |
| | | 5C |
| | Timeout | 00 05 10 EE |
| Output 2 | Value | 49 55 01 00 00 00 00 00 |
| | Script length | 19 |
| | ScriptPubKey | 66 A3 53 D7 11 42 39 79 F5 B1 |
| | | D3 63 E0 6F ED B9 0E 64 55 |
| | | 83 |
| | Timeout | 54 24 19 8F |

| | |
|---|---|
| Block lock time | 00 00 00 00 |

This example extended transaction message contains two outputs, Output 1 and Output 2. The timeout value associated with Output 1 is less than 500 million and therefore may correspond to a block height of 0x510EE, or block 332014 in decimal. The timeout value associated with Output 2 is greater than 500 million and therefore may correspond to a number of seconds in the Unix time, or a time of 13:32:53 UTC, Sep. 25, 2014. Therefore, if Output 1 has not been redeemed in a subsequent transaction by the time the block 332014 is finalized, or if Output 2 has not been redeemed in a subsequent transaction by 13:32:53 UTC, Sep. 25, 2014, then the respective output becomes invalidated, and the Bitcoin funds associated with the output are returned to the original Bitcoin address and may be spent again from that Bitcoin address. It should be noted that this example extended transaction message does not contain a designated address for receiving funds from timed-out outputs.

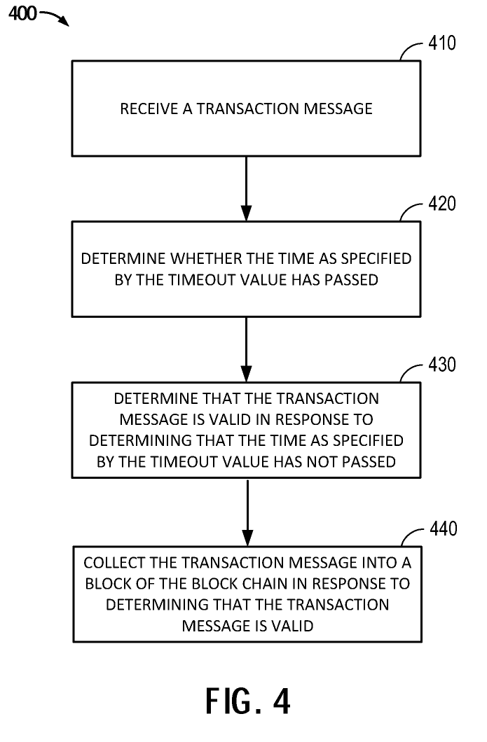

Referring to FIG. 4, a flowchart illustrating an example method 400 implemented with a miner 110 of FIG. 1 for determining whether a transaction message is valid is shown. At block 410, a transaction message may be received, the transaction message referencing in an input a previous output associated with a timeout value. At block 420, it may be determined whether the time as specified by the timeout value has passed. At block 430, in response to determining that the time as specified by the timeout value has not passed, it may be determined that the transaction message is valid. The transaction message may be rejected if it is determined that the time as specified by the timeout value has passed. At block 440, the transaction message may be collected into a block of the block chain in response to determining that the transaction message is valid.

Embodiments of the disclosure are related to a miner apparatus 110 comprising: a memory 235, and a processor 210 coupled to the memory 235, the processor 210 to: receive a transaction message, the transaction message referencing in an input a previous output associated with a timeout value, determine whether the time as specified by the timeout value has passed, determine that the transaction message is valid in response to determining that the time as specified by the timeout value has not passed, and collect the transaction message into a block of a block chain in response to determining that the transaction message is valid.

With reference to the diagram illustrating an example extended transaction message above, Output 1 may be determined to be valid by the processor 210 if block 332014 has not been finalized, and may be determined to be not valid if block 332014 has been finalized. Similarly, Output 2 may be determined to be valid by the processor 210 if the current time is earlier than 13:32:53 UTC, Sep. 25, 2014, and may be determined to be not valid if the current time is later than 13:32:53 UTC, Sep. 25, 2014.

Therefore, according to embodiments of the disclosure, the outputs of a Bitcoin transaction message are associated with timeout values. Bitcoin funds associated with the outputs that have not been redeemed in subsequent transactions by the time specified by the timeout values are either returned to the original address or transferred to another predesignated address. A permanent loss of Bitcoins due to incorrect Bitcoin addresses in the outputs can thus be avoided. Embodiments of the disclosure do not affect the ability of a miner to collect transaction fees, even if all the outputs of a transaction are timed-out and invalidated.

It should be appreciated that although Bitcoin has been described hereinafter as an example, the present disclosure is not so limited and may be adapted for other digital currencies without deviating from its scope.

It should be appreciated that aspects of the invention previously described may be implemented in conjunction with the execution of instructions (e.g., applications) by processor 210 of device 200, as previously described. Particularly, circuitry of the device, including but not limited to processor, may operate under the control of an application, program, routine, or the execution of instructions to execute methods or processes in accordance with embodiments of the invention (e.g., the processes of FIG. 3). For example, such a program may be implemented in firmware or software (e.g., stored in memory and/or other locations) and may be implemented by processors and/or other circuitry of the devices. Further, it should be appreciated that the terms processor, microprocessor, circuitry, controller, etc., refer to any type of logic or circuitry capable of executing logic, commands, instructions, software, firmware, functionality, etc.

Methods described herein may be implemented in conjunction with various wireless communication networks such as a wireless wide area network (WWAN), a wireless local area network (WLAN), a wireless personal area network (WPAN), and so on. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

Example methods, apparatuses, or articles of manufacture presented herein may be implemented, in whole or in part, for use in or with mobile communication devices. As used herein, “mobile device,” “mobile communication device,” “hand-held device,” “tablets,” etc., or the plural form of such terms may be used interchangeably and may refer to any kind of special purpose computing platform or device that may communicate through wireless transmission or receipt of information over suitable communications networks according to one or more communication protocols, and that may from time to time have a position or location that changes. As a way of illustration, special purpose mobile communication devices, may include, for example, cellular telephones, satellite telephones, smart telephones, heat map or radio map generation tools or devices, observed signal parameter generation tools or devices, personal digital assistants (PDAs), laptop computers, personal entertainment systems, e-book readers, tablet personal computers (PC), personal audio or video devices, personal navigation units, wearable devices, or the like. It should be appreciated, however, that these are merely illustrative examples relating to mobile devices that may be utilized to facilitate or support one or more processes or operations described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described storage media may comprise primary, secondary, and/or tertiary storage media. Primary storage media may include memory such as random access memory and/or read-only memory, for example. Secondary storage media may include mass storage such as a magnetic or solid state hard drive. Tertiary storage media may include removable storage media such as a magnetic or optical disk, a magnetic tape, a solid state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

What is claimed is:

1. A method for determining whether a transaction message of a digital currency system is valid, comprising:
receiving the transaction message, the transaction message referencing in an input a previous output associated with a timeout value;
determining whether a time as specified by the timeout value has passed;
determining that the transaction message is valid in response to determining that the time as specified by the timeout value has not passed; and
collecting the transaction message into a block of a block chain in response to determining that the transaction message is valid.

2. The method of claim 1, further comprising:
determining that the transaction message is not valid in response to determining that the time as specified by the timeout value has passed.

3. The method of claim 2, further comprising:
determining that funds associated with the previous output has been returned to an original address or transferred to a predesignated address in response to determining that the transaction message is not valid.

4. The method of claim 3, further comprising:
allowing the funds associated with the previous output to be spent from the original address or the predesignated address.

5. The method of claim 1, wherein the previous output is associated with a transaction-wide timeout value.

6. The method of claim 1, wherein the previous output is associated with an individual timeout value.

7. The method of claim 1, wherein the timeout value indicates either a block height of the block chain or a Unix time.

8. The method of claim 1, wherein the digital currency system is Bitcoin.

9. A miner apparatus of a digital currency system, comprising:
a memory; and
a processor coupled to the memory, the processor to:
receive a transaction message, the transaction message referencing in an input a previous output associated with a timeout value;
determine whether a time as specified by the timeout value has passed;
determine that the transaction message is valid in response to determining that the time as specified by the timeout value has not passed; and
collect the transaction message into a block of a block chain in response to determining that the transaction message is valid.

10. The miner apparatus of claim 9, the processor further to:
determine that the transaction message is not valid in response to determining that the time as specified by the timeout value has passed.

11. The miner apparatus of claim 10, the processor further to:
determine that funds associated with the previous output has been returned to an original address or transferred to a predesignated address in response to determining that the transaction message is not valid.

12. The miner apparatus of claim 11, the processor further to:
allow the funds associated with the previous output to be spent from the original address or the predesignated address.

13. The miner apparatus of claim 9, wherein the previous output is associated with a transaction-wide timeout value.

14. The miner apparatus of claim 9, wherein the previous output is associated with an individual timeout value.

15. The miner apparatus of claim 9, wherein the timeout value indicates either a block height of the block chain or a Unix time.

16. The miner apparatus of claim 9, wherein the digital currency system is Bitcoin.

17. An apparatus, comprising:
means for receiving a transaction message of a digital currency system, the transaction message referencing in an input a previous output associated with a timeout value;
means for determining whether a time as specified by the timeout value has passed;
means for determining that the transaction message is valid in response to determining that the time as specified by the timeout value has not passed; and
means for collecting the transaction message into a block of a block chain in response to determining that the transaction message is valid.

18. The apparatus of claim 17, further comprising:
means for determining that the transaction message is not valid in response to determining that the time as specified by the timeout value has passed.

19. The apparatus of claim 18, further comprising:
means for determining that funds associated with the previous output has been returned to an original address or transferred to a predesignated address in response to determining that the transaction message is not valid.

20. The apparatus of claim 17, wherein the previous output is associated with a transaction-wide timeout value.

21. The apparatus of claim 17, wherein the previous output is associated with an individual timeout value.

22. The apparatus of claim 17, wherein the timeout value indicates either a block height of the block chain or a Unix time.

23. The apparatus of claim 17, wherein the digital currency system is Bitcoin.

24. A non-transitory computer-readable medium comprising code which, when executed by a processor, causes the processor to perform a method comprising:
receiving a transaction message of a digital currency system, the transaction message referencing in an input a previous output associated with a timeout value;
determining whether a time as specified by the timeout value has passed;
determining that the transaction message is valid in response to determining that the time as specified by the timeout value has not passed; and
collecting the transaction message into a block of a block chain in response to determining that the transaction message is valid.

25. The non-transitory computer-readable medium of claim 24, further comprising code for:
determining that the transaction message is not valid in response to determining that the time as specified by the timeout value has passed.

26. The non-transitory computer-readable medium of claim 25, further comprising:
determining that funds associated with the previous output has been returned to an original address or transferred to a predesignated address in response to determining that the transaction message is not valid.

27. The non-transitory computer-readable medium of claim 24, wherein the previous output is associated with a transaction-wide timeout value.

28. The non-transitory computer-readable medium of claim 24, wherein the previous output is associated with an individual timeout value.

29. The non-transitory computer-readable medium of claim 24, wherein the timeout value indicates either a block height of the block chain or a Unix time.

30. The non-transitory computer-readable medium of claim 24, wherein the digital currency system is Bitcoin.
